(19) United States
(12) Patent Application Publication
(10) Pub. No.: US 2015/0341789 A1
(43) Pub. Date: Nov. 26, 2015

(54) PREVENTING CLIENTS FROM ACCESSING A ROGUE ACCESS POINT

(71) Applicant: HANGZHOU H3C TECHNOLOGIES CO., LTD., Hangzhou, Zhejiang (CN)

(72) Inventors: Tao ZHENG, Beijing (CN); Haitao ZHANG, Beijing (CN); Guoxiang XU, Beijing (CN); Zhenyu FU, Beijing (CN)

(21) Appl. No.: 14/652,768

(22) PCT Filed: Oct. 18, 2013
(86) PCT No.: PCT/CN2013/085448

§ 371 Date: Jun. 16, 2015

(30) Foreign Application Priority Data
Dec. 19, 2012 (CN) 201210556408.8

(51) Int. Cl. H04W 12/08; H04W 12/12

(52) U.S. Cl. CPC H04W 12/08; H04W 12/12; H04W 88/08

(57) ABSTRACT

According to an example, a detecting AP may determine whether a rogue AP is in the wireless network. In response to a determination that a rogue AP is in the wireless network, the detecting AP may obtain a wireless channel of the rogue AP and according to the wireless channel of the rogue AP, the detecting AP may transmit on the wireless channel of the rogue AP, a channel switch instruction to a client associated with the rogue AP by simulating an identity of the rogue AP. The channel switch instruction is to instruct the client to switch to a designated new channel.

### BACKGROUND

Conventional Wireless Local Area Network (WLAN) techniques are typically flexible to implement and convenient to deploy. However, often due to the openness of the transmission media and inadequate security, WLAN faces threats from various kinds of attacks. One type of attack is an attack by a rogue Access Point (AP), which may be defined as an AP that has not been authorized and/or lacks the appropriate credentials to operate on a WLAN. In this type of attack, when a legal (or authorized) user connects to a rogue AP, a malicious user may obtain information of the legal user via the rogue AP.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for preventing clients from accessing a rogue AP in a wireless network according to an example of the present disclosure.

FIG. 2 is a schematic diagram illustrating a channel switch instruction according to an example of the present disclosure.

FIG. 3 is a schematic diagram illustrating a method for preventing clients from accessing a rogue AP in a wireless network according to another example of the present disclosure.

FIG. 4 is a schematic diagram illustrating a detecting AP that may be implemented to prevent clients from accessing a rogue AP in a wireless network, according to an example of the present disclosure.

FIG. 5 is a schematic diagram illustrating a detecting AP according to another example of the present disclosure.

### DETAILED DESCRIPTION

For simplicity and illustrative purposes, the present disclosure is described by referring to examples. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In order to avoid potential security risks and provide normal services to wireless users, conventional techniques for preventing clients from accessing rogue APs in a wireless network usually include the scanning of wireless channels periodically by a detecting AP and determining whether there is a rogue AP based on certain filtering conditions. If it is determined that there is a rogue AP, the detecting AP simulates the rogue AP to transmit a large amount of deassociation packets to clients to force the clients to be deassociated from the rogue AP. However, the clients will associate with the rogue AP again within a relatively short period of time. Thus, continuous transmission of the deassociation packets is required to keep the clients from continuing to associate with the rogue AP. The continuous transmission of the deassociation packets, however, occupies a great amount of radio resources and disrupts normal services to users associated with the rogue AP.

In contrast, disclosed herein is a method for preventing clients from accessing a rogue AP in a wireless network, so as to avoid potential security risks caused by the rogue AP and provide normal services to wireless users. Particularly, the method may include determining, by a detecting AP, whether there is a rogue AP in the wireless network. In response to a determination that there is a rogue AP in the wireless network, the detecting AP may obtain a wireless channel of the rogue AP. In addition, the detecting AP may transmit, on the wireless channel of the rogue AP, a channel switch instruction to a client associated with the rogue AP by simulating an identity of the rogue AP to instruct the client to switch to a designated new channel.

Compared with conventional systems, in examples of the present disclosure, if a detecting AP detects the presence of a rogue AP in the wireless network, the detecting AP may simulate the identity of the rogue AP to transmit a channel switch instruction to the client associated with the rogue AP to instruct the client to switch to the designated new channel, so as to remove the association between the client and the rogue AP and further provide a normal service for the user of the client.

According to an example, in the method disclosed herein, a determination may be made by a detecting AP as to whether there is a rogue AP in the wireless network. A “detecting AP” is an AP which is able to detect a rogue AP. In response to a determination that there is a rogue AP, the detecting AP may transmit a channel switch instruction to the client associated with the rogue AP by simulating the identity of the rogue AP. The channel switch instruction may instruct the client to switch to the designated new channel, so as to remove the association between the client the rogue AP. In addition, in order to prevent the client from associating with the rogue AP again, the detecting AP may simulate the identity of the rogue AP to broadcast Beacon packets on the designated new channel to instruct wireless clients that previously associated with the rogue AP to associate with the detecting AP. The client may be a Wi-Fi terminal such as a laptop computer, a tablet computer, a cell phone, etc.

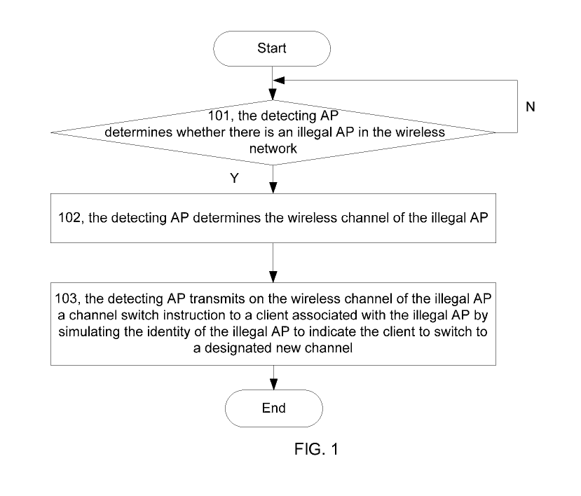

FIG. 1 is a flowchart illustrating a method for preventing clients from accessing a rogue AP in a wireless network according to an example of the present disclosure. The wireless network may include a detecting AP which may determine whether a rogue AP is in the wireless network. In particular, the detecting AP may determine whether a rogue AP is in the wireless network through periodic scanning of wireless channels. In examples of the present disclosure, the wireless network may be a WLAN network. The method may include the following operations.

At block 101, the detecting AP may determine whether a rogue AP is in the wireless network. In response to the detecting AP detecting a rogue AP in the wireless network, block 102 may be performed; otherwise, block 101 may be repeated. In one regard, block 101 may be a scanning operation of wireless channels.

In particular, according to an example, the detecting AP may determine whether a rogue AP is in the WLAN network through periodic scanning of wireless channels at multiple iterations of block 101. In addition, the detecting AP may determine whether a rogue AP is in the WLAN network through monitoring measures such as channel listening. In any regard, the detecting AP may determine the existence of a rogue AP according to a certain filtering condition. The detecting AP may implement a determination process and configuration of the filtering condition that are similar to those in conventional systems and thus this process will not be described in detail herein.

It should be noted that the detecting AP may be a legal AP, e.g., an authorized AP in the wireless network, which is responsible for practical data forwarding services or may be a legal AP that is dedicated for the detection of rogue APs. In addition or alternatively, the detecting AP may be a detecting module inside a legal AP.

At block 102, following the detection of a rogue AP in the wireless network, the detecting AP may obtain the wireless channel of the rogue AP. In addition, the detecting AP may further obtain Basic Service Set Identifier (BSSID) information of the rogue AP and a list of users associated with the rogue AP (i.e., a wireless user list), and may save the above information. The BSSID information includes a MAC address of the rogue AP.

At block 103, the detecting AP may transmit, on the wireless channel of the rogue AP, a channel switch instruction to a client associated with the rogue AP by simulating an identity of the rogue AP to instruct the client to switch to a designated new channel.

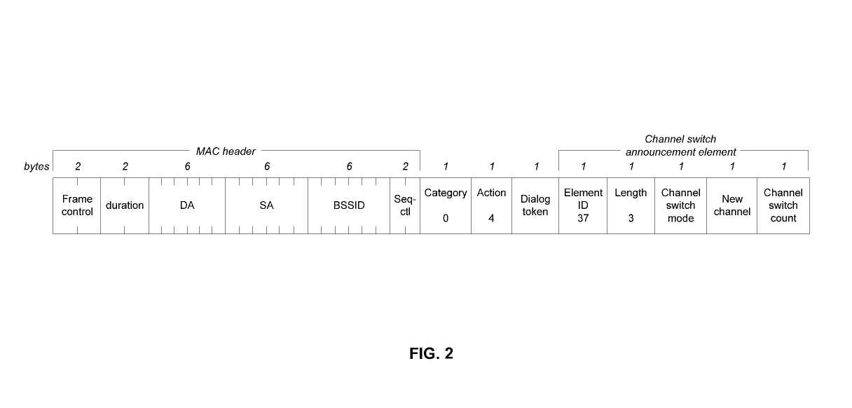

FIG. 2 is a schematic diagram illustrating a channel switch instruction according to an example of the present disclosure. The channel switch instruction may be implemented by an existing channel switch announcement element. As shown in FIG. 2, the detecting AP may use the MAC address of the rogue AP as a source MAC address to transmit the channel switch instruction, so as to simulate the identity of the rogue AP, i.e., the SA field in FIG. 2 is filled with the MAC address of the rogue AP. The channel switch instruction is also depicted as including an index of the designated new channel and a time for switching to the new channel. The channel switch announcement element may be used to notify each client preparing to switch to the designated new channel. In FIG. 2, the field “New channel” denotes the index of the designated new channel, and the field “Channel switch count” denotes the time for switching.

At block 103, the detecting AP may determine all of the clients associated with the rogue AP according to the wireless user list obtained at block 102, and may transmit the channel switch instruction to all of the determined clients.

Through implementation of blocks 101-103, when a detecting AP determines that a rogue AP is in the wireless network, the detecting AP may transmit a channel switch instruction to the client associated with the rogue AP by simulating the identity of the rogue AP to instruct the client to switch to a designated new channel. As such, the association between the client and the rogue AP may be removed and the client may be prevented from associating with the rogue AP again on the wireless channel of the rogue AP.

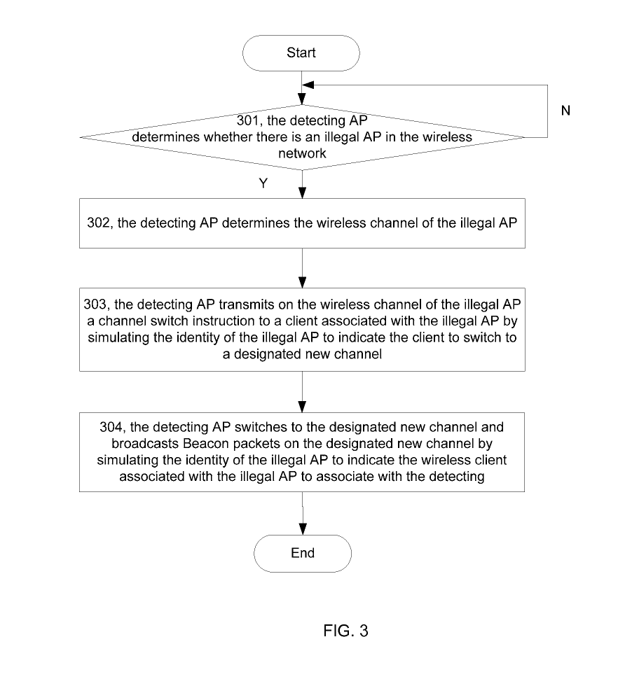

In addition, after block 103, in order to further avoid security risks brought on by the rogue AP and to reduce the probability that the client associates with the rogue AP again, the method may further include a procedure of instructing the client to associate with the detecting AP. This procedure is shown in FIG. 3, which is a flowchart illustrating a method for preventing clients from accessing a rogue AP in a wireless network according to an example of the present disclosure.

In FIG. 3, blocks 301-303 are similar to blocks 101-103, respectively, and descriptions of blocks 301-303 will be not be presented herein.

At block 304, the detecting AP may switch to the designated new channel and may broadcast a beacon packet on the designated new channel by simulating the identity of the rogue AP. The detecting AP may thus instruct the wireless client, which is associated with the rogue AP, to associate with the detecting AP.

After the client switches to the designated new channel, the client is not to transmit an association request on its own initiative. Therefore, in order to cause the client to associate with the detecting AP, the detecting AP may transmit a beacon packet on the designated new channel by simulating the identity of the rogue AP and may respond to a probe request of the user by simulating the rogue AP. After receiving the beacon packet broadcasted by the detecting AP on the designated new channel, the client establishes an association with the detecting AP. In one regard, therefore, because the client does not transmit an association request on its own initiative, the client may be prevented from associating with the rogue AP again after switching to the designated new channel. After switching to the designated new channel, the client may also receive beacon packets transmitted by other legal APs and may establish associations with the other legal APs. The client may also establish an association with another rogue AP on the designated new channel. If the client associates with a rogue AP again, the detecting AP may continue to transmit the channel switch instruction to the client by simulating the identity of the rogue AP to direct the client to another designated new channel.

After the association between the wireless client and the detecting AP is established, the wireless client may perform data packet transmission and receipt operations via the detecting AP and may enter into a normal operating procedure.

As such, a problem in the conventional method for preventing clients from accessing the rogue AP in a wireless network, i.e., the continuous transmission of deassociation packets to prevent the client from associating with the rogue AP again after being deassociated from the rogue AP, the large amount of radio resources required by the continuous transmission of the deassociation packets, and the prevention of services provided for the user, may be resolved.

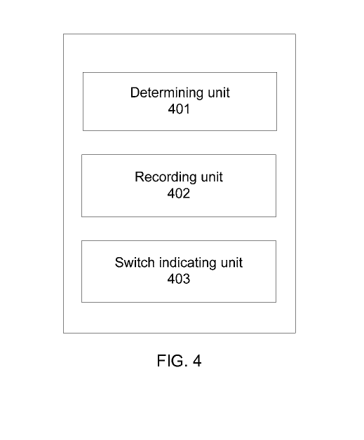

FIG. 4 is a schematic diagram illustrating a structure of a detecting AP that may be implemented to prevent a rogue AP from operating in a wireless network according to an example of the present disclosure. According to an example, the detecting AP may be a detecting module of a legal AP or a dedicated detecting AP. The detecting AP may also be another legal AP responsible for data forwarding services. As shown in FIG. 4, the detecting AP may include a determining unit 401, a recording unit 402, and a switch indicating unit 403.

The determining unit 401 may determine whether a rogue AP is in the wireless network. In particular, the determining unit 401 may determine whether a rogue AP is in the wireless network by periodically scanning wireless channels in the wireless network. In addition, the detecting AP may also determine whether a rogue AP is in the wireless network through implementation of monitoring measures such as channel listening. The detecting AP may determine the existence of the rogue AP according to a conventional filtering condition.

The recording unit 402 may record the wireless channel of the rogue AP if the determining unit 401 determines that a rogue AP is in the wireless network. In particular, the recording unit 402 may record the BSSID information of the rogue AP and a list of wireless users associated with the rogue AP (i.e., a wireless user list). The BSSID information includes a MAC address of the rogue AP.

The switch indicating unit 403 may transmit, on the wireless channel of the rogue AP, a channel switch instruction to each client associated with the rogue AP by simulating the identity of the rogue AP according to the wireless channel recorded by the recording unit 402. The channel switch instruction may instruct the client associated with the rogue AP to switch to a designated new channel.

The switch indicating unit 403 may determine the client associated with the rogue AP according to the wireless user list recorded by the recording unit 402, so as to transmit the channel switch instruction to the client. The switch indicating unit 403 may simulate the rogue AP by using the MAC address of the rogue AP as a source MAC address of the channel switch instruction. The channel switch instruction may include an index of the designated new channel and time for switching to the designated new channel. In the channel switch instruction as shown in FIG. 2, the field “New channel” denotes the index of the designated new channel, and the field “Channel switch count” denotes the time for switching. “SA” denotes the MAC address of the rogue AP.

According to the above, when the detecting AP detects that a rogue AP is in the wireless network, the detecting AP may transmit a channel switch instruction to the client associated with the rogue AP by simulating the identity of the rogue AP. The channel switch instruction is to instruct the client to switch to a designated new channel, which removes the association between the client and the rogue AP and prevents the client from associating with the rogue AP again on the wireless channel of the rogue AP.

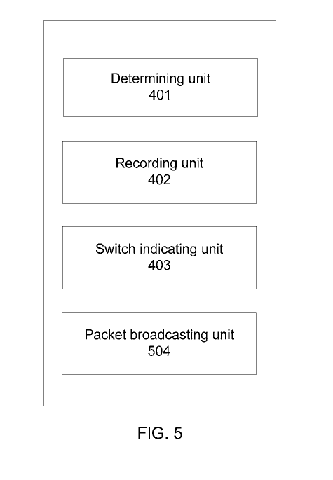

In addition, in order to further eliminate security risks brought on by the rogue AP and to reduce the probability that the client associates with the rogue AP again, the detecting AP may further instruct the client to associate with the detecting AP. FIG. 5 is a schematic diagram illustrating a structure of a detecting AP that is to prevent a rogue AP from operating in a wireless network according to an example of the present disclosure.

As shown in FIG. 5, the detecting AP includes a determining unit 401, a recording unit 402, a switch indicating unit 403, and a packet broadcasting unit 504. The functions of the determining unit 401, recording unit 402, and the switch indicating unit 403 are similar to corresponding units shown in FIG. 4 and descriptions of those units will not be repeated herein.

The packet broadcasting unit 504 may broadcast a beacon packet on the designated new channel by simulating the identity of the rogue AP to instruct the wireless client, which is associated with the rogue AP, to associate with the detecting AP.

After the client switches to the designated new channel, the client is not to transmit an association request on its own initiative. Therefore, in order to cause the client to associate with the detecting AP, the detecting AP may transmit a beacon packet on the designated new channel by simulating the identity of the rogue AP and may respond to a probe request of the user by simulating the identity of the rogue AP. After receiving the beacon packet broadcasted by the detecting AP on the designated new channel, the client establishes an association with the detecting AP. In one regard, therefore, because the client does not transmit an association request on its own initiative, the client may be prevented from associating with the rogue AP again after switching to the designated new channel. After switching to the designated new channel, the client may also receive beacon packets transmitted by other legal APs and may establish associations with the other legal APs. The client may also establish an association with another rogue AP on the designated new channel. If the client associates with a rogue AP again, the detecting AP may continue to transmit the channel switch instruction to the client by simulating the identity of the rogue AP to direct the client to another designated new channel.

After the association between the wireless client and the detecting AP is established, the wireless client may perform data packet transmission and receipt operations through the detecting AP and may enter into a normal operating procedure. As such, a problem in the conventional method for preventing clients from accessing the rogue AP in a wireless network, i.e., the continuous transmission of deassociation packets to prevent the client from associating with the rogue AP again after being deassociated from the rogue AP, the large amount of radio resources required by the continuous transmission of the deassociation packets, and the prevention of services provided for the user, may be resolved.

The above examples may be implemented by hardware, software, firmware, or a combination thereof. For example, the various methods, processes, and functional modules described herein may be implemented by a processor (the term processor is to be interpreted broadly to include a CPU, processing module, ASIC, logic module, or programmable gate array, etc.). The processes, methods, and functional modules may all be performed by a single processor or split between several processors; reference in this disclosure or the claims to a ‘processor’ should thus be interpreted to mean ‘one or more processors’. The processes, methods and functional modules may be implemented as machine readable instructions executable by one or more processors, hardware logic circuitry of the one or more processors or a combination thereof. Further, the examples disclosed herein may be implemented in the form of a software product. The computer software product may be stored in a non-transitory computer readable storage medium and may include a plurality of instructions for making a computer device (which may be a personal computer, a server or a network device, such as a router, switch, access point, etc.) implement the method recited in the examples of the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A method for preventing clients from accessing a rogue Access Point (AP) in a wireless network, wherein the wireless network comprises a detecting AP, the method comprising:
determining, by the detecting AP, whether a rogue AP is in the wireless network;
in response to a determination that a rogue AP is in the wireless network, obtaining, by the detecting AP, a wireless channel of the rogue AP; and
transmitting, by the detecting AP, on the wireless channel of the rogue AP, a channel switch instruction to a client associated with the rogue AP by simulating an identity of the rogue AP to instruct the client to switch to a designated new channel.

2. The method of claim 1, further comprising:
following transmission of the channel switch instruction to the client, broadcasting a beacon packet on the designated new channel by simulating the identity of the rogue AP to instruct the client to associate with the detecting AP.

3. The method of claim 1, wherein transmitting the channel switch instruction on the wireless channel of the rogue AP to the client associated with the rogue AP by simulating the identity of the rogue AP comprises:
obtaining, by the detecting AP, basic service set identifier (BSSID) information of the rogue AP and a wireless user list of the rogue AP;
determining, by the detecting AP, the client associated with the rogue AP according to the wireless user list of the rogue AP; and
simulating, by the detecting AP, the identity of the rogue AP according to the BSSID information of the rogue AP and transmitting the channel switch instruction to the determined client associated with the rogue AP.

4. The method of claim 3, wherein the BSSID information of the rogue AP comprises a MAC address of the rogue AP and wherein simulating the identity of the rogue AP further comprises simulating the identity of the rogue AP by using the MAC address of the rogue AP as a source MAC address of the channel switch instruction.

5. The method of claim 1, wherein transmitting the channel switch instruction further comprises transmitting the channel switch instruction via a channel switch announcement element.

6. The method of claim 1, wherein the channel switch instruction comprises an index of the designated new channel and a time for switching to the designated new channel.

7. A detecting Access Point (AP) to prevent clients from accessing a rogue AP in a wireless network, comprising:
a determining unit to determine whether a rogue AP is in the wireless network;
a recording unit to record a wireless channel of the rogue AP;
a channel switch indicating unit to transmit on the wireless channel of the rogue AP recorded by the recording unit a channel switch instruction to a client associated with the rogue AP by simulating an identity of the rogue AP to instruct the client to switch to a designated new channel; and
a processor to implement the determining unit, the recording unit, and the channel switch indicating unit.

8. The detecting AP of claim 7, further comprising:
a packet broadcasting unit to broadcast, on the designated new channel, a beacon packet by simulating the identity of the rogue AP after the detecting AP switches to the designated new channel to instruct the client to associate with the detecting AP.

9. The detecting AP of claim 7, wherein the recording unit is to record basic service set identifier (BSSID) information of the rogue AP and a wireless user list of the rogue AP;
the switch indicating unit is further to determine the client associated with the rogue AP according to the wireless user list of the rogue AP, simulate the identity of the rogue AP according to the BSSID information of the rogue AP and transmit the channel switch instruction to the client associated with the rogue AP.

10. The detecting AP of claim 9, wherein the BSSID information of the detecting AP comprises a MAC address of the rogue AP and wherein the switch indicating unit is further to use the MAC address of the rogue AP as a source MAC address of the channel switch instruction to simulate the identity of the rogue AP.

11. The detecting AP of claim 7, wherein the channel switch indicating unit is to transmit the channel switch instruction via a channel switch announcement element.

12. The detecting AP of claim 7, wherein the channel switch instruction comprises an index of the designated new channel and a time for switching to the designated new channel.

13. A non-transitory computer readable storage medium on which is store machine readable instructions that when executed by a processor, cause the processor to:
determine whether a rogue AP is in the wireless network;
in response to a determination that a rogue AP is in the wireless network, obtain a wireless channel of the rogue AP; and
transmit on the wireless channel of the rogue AP, a channel switch instruction to a client associated with the rogue AP by simulating an identity of the rogue AP to instruct the client to switch to a designated new channel.

14. The non-transitory computer readable storage medium of claim 13, wherein the machine readable instructions are further to cause the processor to:
broadcast a beacon packet on the designated new channel by simulating the identity of the rogue AP to instruct the client to associate with the detecting AP.

15. The non-transitory computer readable storage medium of claim 13, wherein the machine readable instructions are further to cause the processor to:
obtain basic service set identifier (BSSID) information of the rogue AP and a wireless user list of the rogue AP;
determine the client associated with the rogue AP according to the wireless user list of the rogue AP; and
simulate the identity of the rogue AP according to the BSSID information of the rogue AP and transmit the channel switch instruction to the determined client associated with the rogue AP.
